(19) United States
(12) Patent Application Publication
(10) Pub. No.: US 2016/0298252 A1
(43) Pub. Date: Oct. 13, 2016

(54) HIGH PURITY ALUMINUM COATING WITH ZINC SACRIFICIAL UNDERLAYER FOR ALUMINUM ALLOY FAN BLADE PROTECTION

(71) Applicant: UNITED TECHNOLOGIES CORPORATION, Hartford, CT (US)

(72) Inventor: Lei Chen, South Windsor, CT (US)

(73) Assignee: United Technologies Corporation, Farmington, CT (US)

(21) Appl. No.: 15/037,698

(22) PCT Filed: Dec. 11, 2014
(86) PCT No.: PCT/US2014/069651

§ 371 Date: May 19, 2016

Related U.S. Application Data
(60) Provisional application No. 61/914,543, filed on Dec. 11, 2013.

(51) Int. Cl. C25D 5/10; C25D 3/44; F04D 29/38; C25D 5/44; C25D 3/56; C25D 3/22; C23C 18/54

(52) U.S. Cl. CPC C25D 5/10; C25D 3/22; C25D 3/44; C23C 18/54; C25D 5/44; C25D 3/565; F04D 29/388; F05D 2260/95; F05D 2300/611

(57) ABSTRACT

A coating system for an aluminum component includes a substrate formed from an aluminum material, a zinc or zinc alloy sacrificial layer deposited on the substrate, and an aluminum coating deposited over the zinc or zinc alloy sacrificial layer.

### BACKGROUND

The present disclosure relates to a coating system for providing protection to aluminum alloy components such as fan blades.

Aluminum alloys are extensively used in the aeronautical industry due to their high strength and low density. They are used to form turbine engine components such as fan blades. Pitting and intergranular corrosion of the aluminum alloys is one key risk to be mitigated to ensure reliability. It has been found that intermetallic particles are primarily responsible for susceptibility of the aluminum alloys to localized corrosion.

Additionally, use of aluminum alloys as the body of engine fan blades often requires a titanium leading edge to avoid erosion damage of the blade. However, factory isolated titanium leading edges may short in the field via tip rubs and may give rise to conductive contaminates (soot) and dielectric bond breakdown due to mechanical or electrical stresses, which may lead to an aggressive corrosion attack and even galvanic corrosion enabled by the coupling of very active aluminum alloy and more inert titanium alloys.

Aluminum alloy clad aluminum alloys provide higher resistance to pitting, in particular when the surface is protected with either a chromate conversion coating and/or a chromate primer. Further protection results from the sacrificial clad when the base alloy is exposed. Nonetheless, the mechanical cladding cannot be readily applied to parts with complex geometry such as engine fan blades.

Pure aluminum coating has been shown to be capable of protecting aluminum alloys and it can enable trivalent chromium processing as a green alternative to chromate conversion coatings. However, pure aluminum is not sacrificial to the alloy fan blade body.

There remains a need for a way to protect aluminum alloys from pitting and intergranular corrosion using a barrier layer when the protection layer is intact while still retaining protection even when the barrier layer is broken to expose the base alloy.

### SUMMARY

In accordance with the present disclosure, there is provided a coating system for an aluminum component which broadly comprises a substrate formed from an aluminum material, a zinc material sacrificial layer deposited on the substrate, and an aluminum coating deposited over the zinc sacrificial layer.

In another and alternative embodiment, the sacrificial layer may be formed from zinc.

In another and alternative embodiment, the sacrificial layer may be formed from a zinc alloy.

In another and alternative embodiment, the sacrificial layer may have a thickness of less than 10 microns and the aluminum coating may have a thickness in the range of from 5 microns to 50 microns.

In another and alternative embodiment, the substrate may be formed from an aluminum alloy.

In another and alternative embodiment, the aluminum coating may be aluminum.

In another and alternative embodiment, the aluminum coating may be an electroplated aluminum coating.

In another and alternative embodiment, the substrate may be a turbine engine component.

In another and alternative embodiment, the substrate may be a fan blade used in a turbine engine.

Further, in accordance with the present disclosure, there is provided a method for forming a coating system which enhances resistance against corrosion which broadly comprises the steps of: providing a substrate formed from an aluminum material; forming a zinc material underlayer on a surface of the substrate; and forming an aluminum coating on the zinc material underlayer.

In another and alternative embodiment, the underlayer forming step may comprise depositing a zinc or zinc alloy on the surface using at least one zincating process.

In another and alternative embodiment, the method may further comprise plating zinc or a zinc alloy onto the deposited zinc or zinc alloy.

In another and alternative embodiment, the aluminum coating forming step may comprise depositing aluminum or an aluminum alloy onto said underlayer.

In another and alternative embodiment, the aluminum coating forming step may comprise electroplating aluminum onto the underlayer.

In another and alternative embodiment, the coating forming step may comprise chromate conversion coating or trivalent chromium process (TCP) treatment of the aluminum coating as a passivation method.

Other details of the high purity aluminum coating with zinc sacrificial underlayer for aluminum alloy fan blade protection are set forth in the following detailed description and the accompanying drawings, wherein like reference numerals depict like elements.

### BRIEF DESCRIPTION OF THE DRAWINGS

FIG. 1 is a schematic representation of a coating system in accordance with the present disclosure;

FIG. 2 is a schematic representation of the protection rendered by the composite layers when the top coating fails; and

FIG. 3 is a TEM image of a composite Al—Zn sacrificial coating coated aluminum alloy.

### DETAILED DESCRIPTION

The present disclosure relates to applying a corrosion resistant aluminum coating with a sacrificial underlayer to protect aluminum alloy components, such as fan blades, from localized corrosion and galvanic corrosion. The sacrificial underlayer, in addition to providing improved protection, enhances the adhesion of the aluminum coating. In order to gain full coverage of the aluminum alloy component, the aluminum coating may be applied by electrodeposition or by cathodic arc deposition.

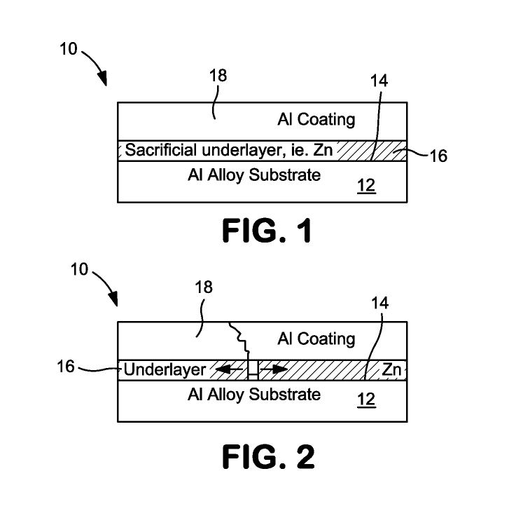

Referring now to FIG. 1, there is shown a coating system 10 in accordance with the present invention. The coating system 10 includes a substrate 12 which may be formed from an aluminum alloy. For example, the substrate 12 may be formed from aluminum alloy 6061. The substrate 12 may be a turbine engine component such as a fan blade.

Deposited onto the surface 14 of the substrate 12 is a sacrificial underlayer 16. The sacrificial underlayer 16 may be formed from pure zinc or a zinc alloy. The underlayer 16 may be deposited onto the surface using a zincating process, preferably multiple zincate processing. A zinc coating can be formed on aluminum alloys by an immersion coating process in which aluminum is chemically exchanged in solution. In the zincate process, the native oxide layer of aluminum is removed in an alkaline solution. The aluminum exposed thereby reacts with zincate ions in a zincate solution to form a zinc layer on the aluminum alloy substrate. This process is known in the industry. Other zincating processes can also be used. The sacrificial underlayer 16 formed from pure zinc or a zinc alloy displaces the native aluminum oxide that tends to weaken the bonding of a coating applied to the aluminum alloy forming the substrate 12.

Once a seed layer is deposited using the zincating process, a zinc or zinc alloy may be subsequently deposited to attain better control of the underlayer composition and mechanical strength, such as by electroplating, following optional anodic etching in the same solution used for the deposition. The zinc plating solution may be an ionic liquid or deep eutectic solvent solution, which is a non-acidic and basic solution to avoid attacking the base aluminum alloy. The solution can comprise choline chloride, zinc chloride, auxiliary solvents and additives. The molar ratio of the choline chloride and zinc chloride ranges from 0.5 to 3.5. Polar aprotic and polar protic solvents can be used to adjust the viscosity and conductivity of the plating bath. The solvents include formic acid, citric acid, isopropanol (IPA), water, acetic acid, glycine (aminoacetic acide) and ethylene glycol. Preferred auxiliary solvent content is from 10 to 80 vol % relative to the mixture of choline chloride and metal chlorides on a premixing basis. Examples of additives used to further improve the zinc underlayer properties include sodium dodecyl sulfate, fluorosurfactants, cetyl trimethylammonium bromide (CTAB), or cetyl, trimethylammonium chloride (CTAC).

The zinc plating solution allows for better control of the electrochemical etching of the zinc displacement layer 16 by eliminating spontaneous reaction occurring in traditional zinc plating solutions, containing either acidic or basic chemistry.

After the underlayer 16 has been formed on the substrate 12, an aluminum coating 18 is deposited onto the sacrificial or under layer 16. The aluminum coating 18 may be pure aluminum. Alternatively, for certain applications, the aluminum coating 18 may be an aluminum alloy which contains more than 50 wt % aluminum. The aluminum coating 18 may be electroplated aluminum formed using either triethyaluminium/toluene solutions, such as an electroplating solution available from ALUMIPLATE®, or in room temperature ionic liquids including Lewis acidic 1-ethyl-3-methylimidazolium chloride or 1-butyl-3-methylimidazolium chloride and an aluminum salt, for example. Forming an electroplated aluminum coating 18 produces a high purity, dense aluminum coating 18 with non-line-of-sight advantage compared with alternative technologies such as ion vapor deposition.

Referring now to FIG. 2, there is shown the protection rendered by the zinc or zinc alloy underlayer 16 when the top aluminum coating 18 fails such as by cracking. The top coating failure allows electrolytes to penetrate through the barrier layer, which would create a corrosive environment that could lead to corrosion damage of the base aluminum alloy. With the presence of a more active zinc underlayer, corrosion occurs on the sacrificial zinc layer to delay the attack of the base alloy to allow mitigation actions to be taken during next inspection and maintenance. It is also expected that the corrosion of the zinc layer would progress laterally as opposed to a much more aggressive damage penetrating the base alloy without the protection of the sacrificial layer.

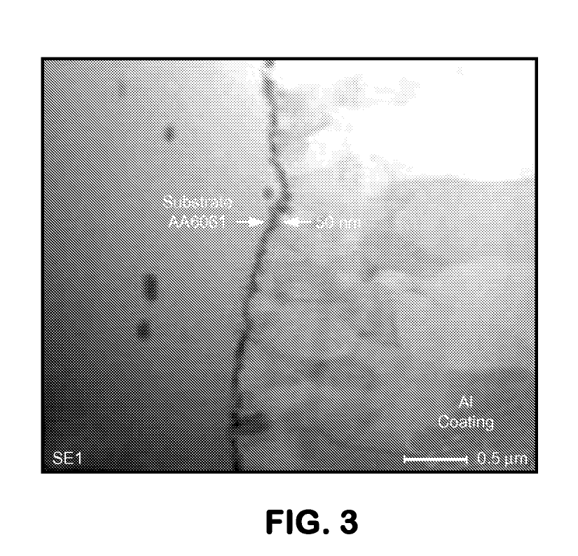

Referring now to FIG. 3, there is shown a transmission electron microscopy (TEM) image of an aluminum alloy 6061 substrate having an aluminum coating plated from an ionic liquid. It is clear from this image that a thick zinc underlayer 16 is well adherent to the substrate 12. The zinc is extremely thin in this case, but can be made thicker with complete dense structure to meet durability design requirement, via zinc electroplating on this seed layer.

In an exemplary coating system, the zinc or zinc alloy underlayer 16 may have a thickness of from about 0.01 microns to less than 10 microns. The aluminum coating 18 may have a thickness in the range of from 5 to 50 microns.

The coating system 10 of the present disclosure provides a double protection for corrosion enabled by a top aluminum coating and a sacrificial underlayer on the aluminum alloy substrate. The coating system 10 also provides full coverage of an entire fan blade as a result of using non-line of sight coating application techniques. Still further, a dense and pure aluminum coating imparts more effective corrosion protection enabled by chromate treatment or trivalent chromium treatment containing inhibitors compared with aluminum alloys.

Still further, a pure aluminum coating (1) is amenable to more benign conversion coating treatment, i.e. TCP, and (2) can reduce or eliminate fatigue debit resulting from an anodizing or pickling process applied to aluminum alloy conventionally. Still further, the displacement layer formed from zinc or a zinc alloy yields an adherent aluminum coating. Finally, the coating system 10 provides an enhanced resistance to pitting and intergranular corrosion.

There has been provided a high purity aluminum coating with a zinc sacrificial underlayer for aluminum alloy fan blade protection. While the high purity aluminum coating with zinc sacrificial underlayer for aluminum alloy fan blade protection has been described in the context of specific embodiments thereof, other unforeseen alternatives, modifications, and variations may become apparent to those skilled in the art having read the foregoing description. Accordingly, it is intended to embrace those alternatives, modifications, and variations as fall within the broad scope of the appended claims.

What is claimed is:

1. A coating system for an aluminum component which comprises:
a substrate formed from an aluminum material;
a zinc material sacrificial layer deposited on said substrate; and
an aluminum coating deposited over said zinc sacrificial layer.

2. The coating system of claim 1, wherein said sacrificial layer is zinc.

3. The coating system of claim 1, wherein said sacrificial layer is a zinc alloy.

4. The coating system of claim 1, wherein said sacrificial layer has a thickness of less than 10 microns and said aluminum coating has a thickness in the range of from 5 microns to 50 microns.

5. The coating system of claim 1, wherein said substrate is an aluminum alloy.

6. The coating system of claim 1, wherein said aluminum coating is pure aluminum.

7. The coating system of claim 1, wherein said aluminum coating is an electroplated aluminum coating.

8. The coating system of claim 1, wherein said substrate is a turbine engine component.

9. The coating system of claim 1, wherein said substrate is a fan blade used in a turbine engine.

10. A method for forming a coating system which enhances resistance against corrosion comprising the steps of:
providing a substrate formed from an aluminum material;
forming a zinc material underlayer on a surface of said substrate; and
forming an aluminum coating on said zinc material underlayer.

11. The method of claim 10, wherein said underlayer forming step comprises depositing a zinc or zinc alloy on said surface using at least one zincating process.

12. The method of claim 11, further comprising plating zinc or a zinc alloy onto said deposited zinc or zinc alloy.

13. The method of claim 10, wherein said aluminum coating forming step comprises depositing aluminum or an aluminum alloy onto said underlayer.

14. The method of claim 10, wherein said aluminum coating forming step comprises electroplating aluminum onto said underlayer.
